(19) United States
(12) Patent Application Publication
(10) Pub. No.: US 2011/0314557 A1
(43) Pub. Date: Dec. 22, 2011

(54) Click Fraud Control Method and System

(75) Inventor: Jeffrey Barrett Marshall, South San Francisco, CA (US)

(73) Assignee: ADKNOWLEDGE, INC., Kansas City, MO (US)

(21) Appl. No.: 13/161,558

(22) Filed: Jun. 16, 2011

Related U.S. Application Data
(60) Provisional application No. 61/355,309, filed on Jun. 16, 2010.

(51) Int. Cl. G06F 21/24

(52) U.S. Cl. 726/27

(57) ABSTRACT

The disclosed subject matter relates to methods, systems, and computer-usable storage mediums for detecting and reducing the occurrence of fraud in obtaining virtual currency from advertisers for use in network-based virtual persistent worlds.

### CROSS REFERENCES TO RELATED APPLICATIONS

This application claims priority from and is related to commonly owned U.S. Provisional Patent Application, Ser. No.: 61/355,309, entitled: Click Fraud Control Method and System, filed Jun. 16, 2010, the disclosure of which is incorporated by reference herein.

### TECHNICAL FIELD

The present disclosed subject matter relates generally to virtual currency used in applications and games on online networks, such as the Internet.

### BACKGROUND

Internet-based video games and other software that provide a persistent online world often involve an economic system for the exchange of virtual goods and services. The economies of such online worlds are based on virtual currencies unique to the online worlds. However, the currency can be earned in-game or purchased and credited to a user's account using real-world money, such as U.S. dollars. Examples of such virtual worlds and currencies include Linden Dollars in the online world of Second Life® from Linden Research, Inc., California, USA and ISK in the online world of Eve Online® from CCP hf., Iceland.

Recognizing the potential to attract potential customers, advertisers have begun to incentivize users of such online worlds to view advertisements, provide information about themselves, and/or make purchases in exchange for virtual currency. Advertisers are interested in maximizing the return on the advertising dollars they spend, by displaying their promotions to the most qualified consumer leads possible and avoiding displaying their promotions to computers programmed to masquerade as humans and making sales to people using stolen credit card information.

### SUMMARY OF THE INVENTION

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen (monitor) or computer screen display, for example, an activatable portion or link, that causes an action of the various software and or hardware supporting the computer screen display.

A banner is a graphic that appears on the monitor or screen (“monitor” and “screen” of a computer used interchangeably herein) of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as the destination that they link to is determined at the time the creative is activated, which may be upon the loading of a web page or the opening of an electronic communication, or e-mail with the creative, or at the time the creative is clicked on. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipient's browsing application or browser to be directed to the target web site corresponding to the activated link.

A “client” is an application that runs on a computer, workstation or the like and relies on a server to perform some operations, such as sending and receiving email.

“n” and “nth” in the description below and the drawing figures represents the last member of a series or sequence of servers, databases, caches, components, listings, links, data files, etc.

“Click-through” or “click-throughs” are industry standard terms for a user clicking on a link in an “electronic object,” such as an e-mail, creative, banner, listing on a web site, for example, a web site of a search engine, or the like, and ultimately having their browser directed to the targeted data object, typically a web site, associated with the link.

The present disclosed subject matter is directed to methods, systems, and computer-usable storage mediums for detecting and reducing the occurrence of fraud in obtaining virtual currency from advertisers for use in network-based virtual persistent worlds.

The present disclosed subject matter provides advertisers, advertisement networks, website promoters and entities associated therewith, brokers, advertising agencies, application service providers or others (collectively “Promoters”) providing opportunities to users to obtain virtual currency in association with an advertisement, promotion, or sale (collectively “Offers”) over the Internet, a way to reduce fraudulent activity in association with said Offers. More specifically, the disclosed subject matter provides an electronic object, for example a web page, containing an one or more banners, creatives, or other links associated with Offers (hereinafter an “Offer Wall”) and ways for tracking the behavior of a user with respect to the Offers. The Offer Wall is, for example, provided to a user by a monitoring entity. Links associated with Offers provided on the Offer Wall do not link directly to an Offer, but instead link to the monitoring entity. Upon the occurrence of a click-through by a user, the monitoring entity receives notification of the click as well as information about the identity of the user and the Offer that the user wishes to visit, and redirects the user to the corresponding Offer.

By linking first to the monitoring entity, the monitoring entity is able to act as an intermediary between the user and an Offer. This allows the monitoring entity to collect information about the identity of the user, the speed at which the user is activating links to Offers, and which Offers are being visited by the user. It also allows the monitoring entity to determine if the user is likely to be committing fraud because the user is visiting offers at an inhumanly possible or at least suspicious speed and/or is repeatedly purchasing virtual currency in rapid succession over a short time. Further, by acting as an intermediary, the monitoring entity can act as a gate keeper, refusing to let the user visit further Offers if it appears that the user is engaging in fraud.

Using the above information collected from a user's click-through, in association with a “Risk Score,” a number representing the potential risk of fraud associated with each Offer, the monitoring entity can calculate a “Fraud Score,” a number representing the likelihood that the user is fraudulently obtaining virtual currency via the Offers on the Offer Wall. If the fraud score exceeds a predetermined threshold, the monitoring entity may block access to the Offer wall and/or block redirection of links on the Offer Wall to the actual Offers.

An embodiment of the disclosed subject matter is directed to a method for detecting fraud in obtaining virtual currency over a communications network. The method includes a computerized component linked to the communications network receiving, over the communications network, an indication of a click. The click is a click to a link to an Offer to obtain virtual currency and the click is associated with a user computer linked to the communications network. The method also includes determining whether the user computer has been assigned a Fraud Score representing the likelihood that the user computer is engaged in fraud.

A further embodiment of the disclosed subject matter is the above-disclosed method, additionally including obtaining a Fraud Score. This step includes obtaining the Fraud Score if a Fraud Score has been assigned for the user computer. If a Fraud Score has not been assigned for the user computer, then the next step is to assign a Fraud Score for the user computer. This includes assigning a Fraud Score of zero to the user computer. Further, the method includes evaluating the Fraud Score. If the Fraud Score of the user computer is greater than a pre-established maximum threshold, then no further action is taken. However, if the Fraud Score of the user computer is less than the maximum threshold, then the Fraud Score is increased by a Risk Score associated with the Offer, and the user computer is redirected to the Offer to obtain virtual currency. Additionally, the method includes continuously decreasing the Fraud Score of the user computer over time.

Another embodiment of the disclosed subject matter is directed to a method for detecting and reducing fraud in obtaining virtual currency. The method includes receiving an indication of a click by a user on an electronic object (Offer Wall) containing an arrangement of links to opportunities for a user to obtain virtual currency (Offers). The electronic object (Offer Wall) may be, for example, a web page or web site, linked in some way to a server for tracking activities of a user with respect to the opportunities for obtaining virtual currency (again, the Offers). The method further includes upon receiving an indication of a click by the user on a link to an opportunity to obtain virtual currency (Offer) on the electronic object (Offer Wall), correlating a user ID (Identifier or Identification), IP (Internet Protocol) address, and/or device ID associated with the user and obtaining information about which link to an opportunity to obtain virtual currency (Offer) the user clicked on. The next step is referencing a first database of scores, each score representing a likelihood of fraudulent activity (Fraud Score) and each score being associated with a user ID, IP address, and/or device ID. The method further includes determining if the first database includes an existing score (Fraud Score) for the user's user ID, IP address, and/or device ID, and if not, adding a score (Fraud Score) of zero to the first database in association with the user's user ID, IP address, and/or device ID.

The next step is to reference a second database containing a number representing a maximum threshold at which any activity by the user will be ignored or blocked by the server, and determine if the score (Fraud Score) associated with the user's user ID, IP address, and/or device ID is equal to or greater than the maximum threshold. If the score (Fraud Score) is greater than or equal to the maximum threshold, the next step is to take no further action in response to the indication of the click. Otherwise, the next step is to reference a third database which contains scores (Risk Scores) each representing a level of risk associated with each opportunity arranged on the electronic object (Offer Wall) and to retrieve a score (Risk Score) in the third database corresponding to the link to an opportunity to obtain virtual currency (Offer) the user clicked on. Then next step is to increase the score (Fraud Score) from the first database by the score (Risk Score) from the third database and re-save the score (Fraud Score) in the first database. The next step is to redirect the user to the opportunity (Offer) corresponding to the user's click on the electronic object (Offer Wall). The method further includes continuously decreasing the score (Fraud Score) in the first database over time.

Another embodiment of the disclosed subject matter is a system for detecting and reducing fraud in obtaining virtual currency. The system includes at least one server containing at least one computer processor, a memory, a connection to a computer network, and a connection to at least three databases located in said memory or on said computer network, the memory containing computer processor executable instructions for carrying out the methods disclosed above.

A further embodiment of the disclosed subject matter is a computer-usable storage medium. The computer usable storage medium contains computer processor executable instructions for carrying out the methods disclosed above. Another embodiment is directed to a computer-implemented method for detecting fraud in obtaining virtual currency over a communications network. The method includes receiving, by at least one first server linked to the communications network, data associated with an activation of a link in a first data object to the at least one first server; analyzing, by the at least one first server, the data associated with the activation of the link to obtain an identifier associated with at least one of i) the computer of the user linked to the communications network, or ii) the user, associated with the activation of the link; obtaining a fraud score for the obtained identifier, by the at least one first server; comparing, by the at least one first server, the obtained fraud score to a threshold fraud score; and the at least one first server i) redirecting the browsing application of the computer of the user to a target data object if the obtained fraud score is below the threshold fraud score, or ii) blocking browser access to the target data object if the obtained fraud score is above the threshold fraud score. Additionally, the first data object includes an offer wall and the target data object includes a web site linked to the offer wall. The browser of a computer of a user is redirected from the offer wall to the web site linked to the offer wall, upon an activation of the link in the offer wall.

Another embodiment is directed to a system for detecting fraud in obtaining virtual currency over a communications network. The system comprises at least one server for linking to a communications network comprising. The at least one server includes a storage medium for storing computer components; and a processor for executing the computer components. The computer components include a first component for receiving data associated with an activation of a link in a first data object to the at least one first server; a second component for analyzing the data associated with the activation of the link to obtain an identifier associated with at least one of i) the computer of the user linked to the communications network, or ii) the user, associated with the activation of the link; a third component for obtaining a fraud score for the obtained identifier; a fourth component for comparing the obtained fraud score to a threshold fraud score; and a fifth component for i) redirecting the browsing application of the computer of the user to a target data object if the obtained fraud score is below the threshold fraud score, or ii) blocking browser access to the target data object if the obtained fraud score is above the threshold fraud score.

Another embodiment is directed to a system for detecting fraud in obtaining virtual currency over a communications network. The system includes at least one first database for storing fraud scores associated with at least one of, users, internet protocol addresses or computers associated with users, which are linked to the communications network; at least one second database for maintaining threshold fraud scores; and, at least one server linked to the communications network. The at least one server is configured for receiving data associated with an activation of a link in a first data object to the at least one first server; analyzing the data associated with the activation of the link to obtain an identifier associated with at least one of i) the computer of the user linked to the communications network, or ii) the user, associated with the activation of the link; obtaining a fraud score for the obtained identifier from the at least one first database; comparing the obtained fraud score to a threshold fraud score from the at least one second database; and either i) redirecting the browsing application of the computer of the user to a target data object if the obtained fraud score is below the threshold fraud score, or ii) blocking browser access to the target data object if the obtained fraud score is above the threshold fraud score.

### BRIEF DESCRIPTION OF THE DRAWINGS

Attention is now directed to the drawing figures, where like or corresponding numerals indicate like or corresponding components. In the drawings:

FIG. 1 is a diagram of an exemplary system supporting the disclosed subject matter;

FIG. 2 is a flow diagram (flow chart) detailing an exemplary process performed in accordance with the disclosed subject matter;

FIG. 3 is a screen shot of an offer wall received as part of the process detailed in FIG. 2; and

FIG. 4 is a diagram of screen shots which are portions of the process of FIG. 2.

### DETAILED DESCRIPTION OF THE DRAWINGS

This document references trademarks and URLs which are both real and fictitious. For those trademarks which are real, these trademarks are the property of their respective owners, and all trademarks and URLs are used for example purposes only.

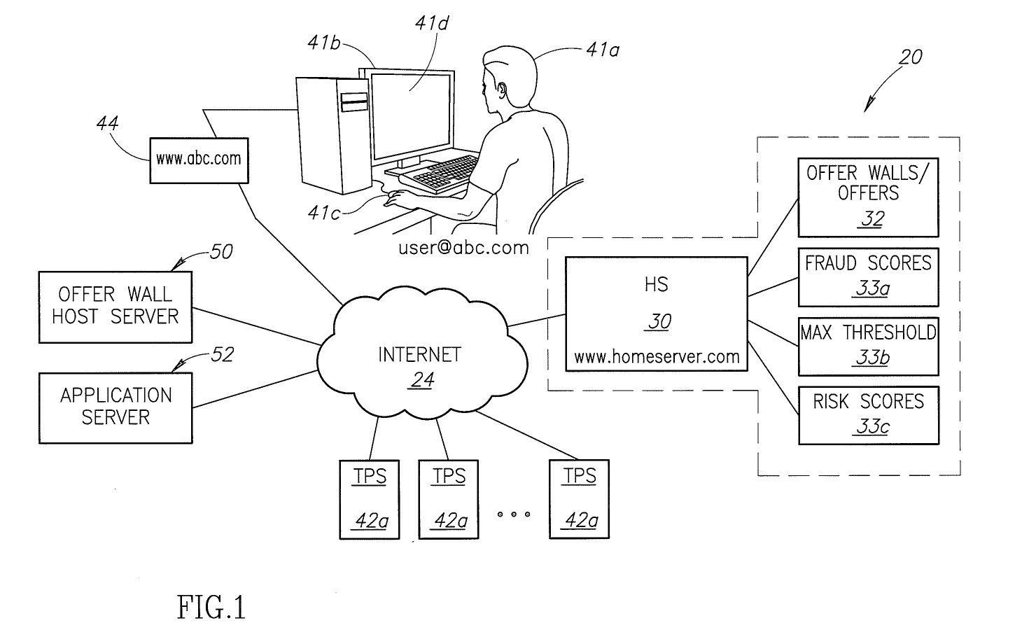

FIG. 1 is a diagram showing the present disclosed subject matter in an exemplary operation. The present disclosed subject matter is shown as a system 20, formed of various servers and server components that are linked to a network or communications network, such as a wide area network (WAN), that may be, for example, the Internet 24. Throughout this document, the terms “linked” and all of its derivatives, includes wired or wireless connections or combinations thereof, for electronic and/or data communication, direct or indirect, between any of the computerized components detailed herein or any of the aforementioned computerized components and the communications network, e.g., a public network such as the Internet 24.

There are, for example, one or more servers that form the system 20, with the main computerized component of the system 20 including the home server (HS) 30, also known as the main server. Additionally, the system 20 is shown in operation as linked, over the communications network, e.g., the Internet 24, to one or more third-party servers (TPS) 42a-42n, as well as additional servers, for example, a domain server 44, for example, for the domain of the URL www.abc.com, offer wall host servers, represented by the server 50, and application servers, represented by the server 52.

The third-party servers are controlled, for example, by Promoters, including advertisers or other entities that may or may not be related to the entity associated with the home server (HS) 30. In this example, the servers 30, 42a-42n, 44, 50 and 52 are linked to the Internet 24 and are in communication with one another. The servers 30, 42a-42n, 44, 50 and 52 contain multiple components for performing the methods disclosed herein. The components are based in hardware, software, or combinations thereof. The servers 30, 42a-42n, 44, 50 and 52 may also have internal storage media and/or be associated with external storage media. The servers 30, 42a-42n, 44, 50 and 52 are linked (either directly or indirectly) to an endless number of other servers, computers, and the like, via the Internet 24.

Also shown in FIG. 1 is an exemplary user 41a who has a computer 41b (such as a multimedia personal computer with a Pentium® CPU that employs a Windows® operating system) that is linked to the Internet 24 (via the domain server 44 for the domain abc.com) and which uses a web browser, browsing software, application, or the like to access web sites or web pages from various servers and the like, on the Internet 24. Exemplary web browsers/web browsing software include Internet Explorer® from Microsoft, Redmond, Wash., and Mozilla Firefox® from Mozilla Foundation, Mountain View, Calif. The computer 41b further comprises a mouse 41c and a monitor 41d.

While various servers and computers have been listed, this is exemplary only, as the present disclosed subject matter can be performed on an endless number of servers, computers, and associated components that are in some way linked to a network, such as the Internet 24. Additionally, all of the aforementioned servers and computers include components for accommodating various functions, in hardware, software, or combinations thereof, and typically include storage media, either therein or associated therewith. Also, the aforementioned servers, computers, computerized components, storage media, and other components can be linked to each other or to a network, such as the Internet 24, either directly or indirectly.

The home server (HS) 30 is of an architecture that includes one or more components, modules, engines, and the like, in software and/or hardware, for providing numerous additional server functions and operations, for example, comparison and matching functions, policy and/or rules processing, various search and other operational engines, browser directing and redirecting functions, and the like. The home server (HS) 30 includes various processors, including microprocessors, for performing the server functions and operations detailed herein, including those for generating and supporting HTML documents and its associated data, such as java script and the like, for monitoring time on a web site or web page as well as hardware and software for analyzing the recorded time, as well as for detecting invalid or fraudulent clicks based on their positioning inside browser windows. U.S. patent application Ser. No. 11/844,983 (U.S. Patent Application Publication No. U.S. 2008/0052629 A1), the disclosure of which is incorporated herein by reference, discloses further information on this functionality of the home server (HS) 30.

The home server (HS) 30 may also include storage media, devices, etc, either internal or associated therewith, which are operationally linked to the components, modules, engines, and the like, listed above for the home server 30. This storage media may store documents and/or data corresponding to these documents, such as hypertext markup language (HTML) coded documents (and/or data corresponding thereto), that are sent by the home server (HS) 30 (for example, as HTML coded documents), detailed below. By “home server”, it is meant all servers and components necessary to support the home server (HS) 30 in the requisite function, such as imaging servers, as disclosed in U.S. patent applications Ser. Nos. 10/915,975 (U.S. Patent Application Publication No. U.S. 2005/0038861 A1), Ser. No. 11/361,480 (U.S. Patent Application Publication No. U.S. 2006/0212349 A1) and Ser. No. 11/774,106 (U.S. Patent Application Publication No. U.S. 2008/0098075 A1), all three of these patent applications, the disclosures of which are all incorporated by reference herein, e-mail API servers, and tag servers, as disclosed in U.S. patent applications Ser. No. 11/774,106, and caches, databases and the like, as disclosed in U.S. patent application Ser. Nos. 10/915,975, 11/361,480 and 11/774,106, respectively. For explanation purposes, the home server (HS) 30 has a uniform resource locator (URL) of, for example, www.homeserver.com.

The home server 30 may also include, databases, caches and the like, for example, databases for offer walls 32, fraud scores 33a, maximum (Max) thresholds 33b (for fraud scores), and risk scores 33c. The operations of these databases are detailed further below.

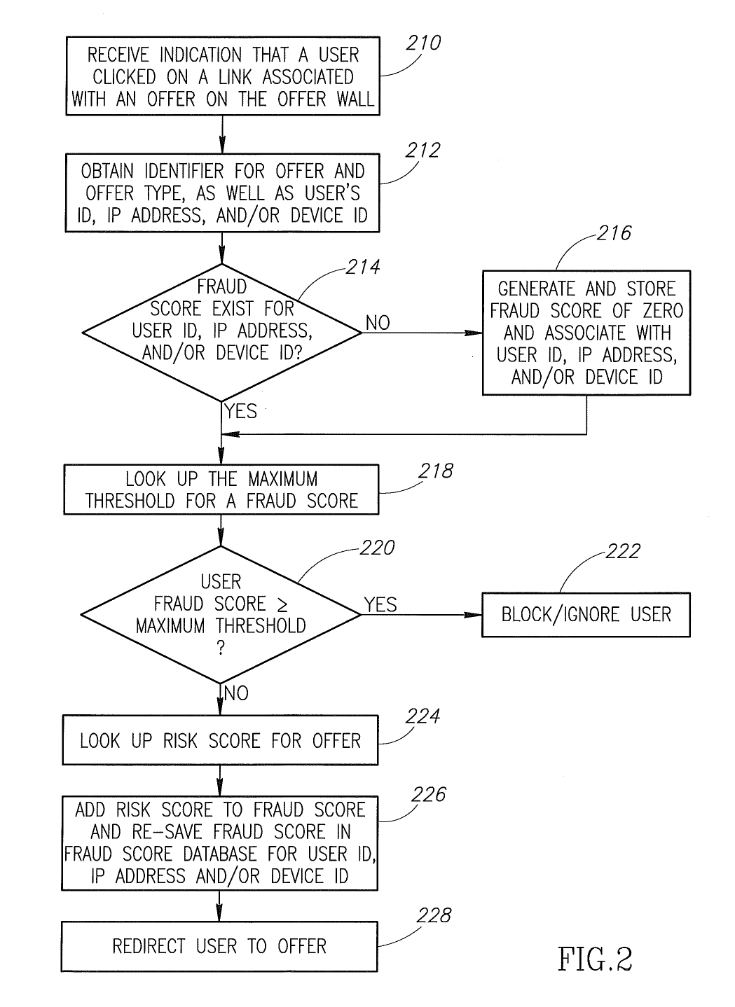

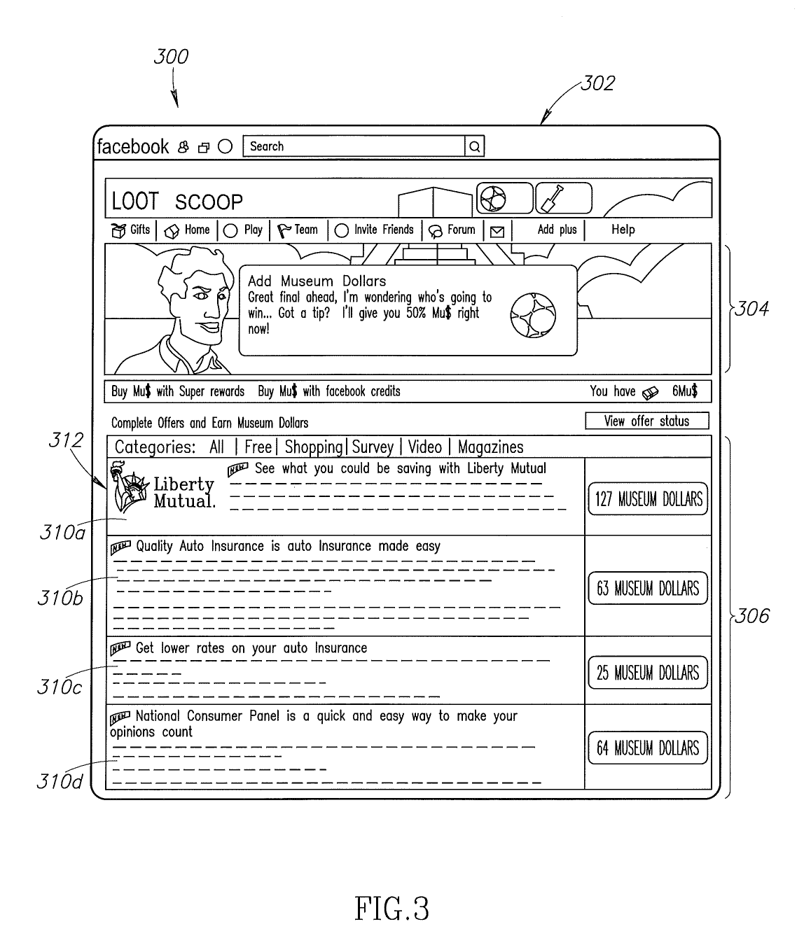

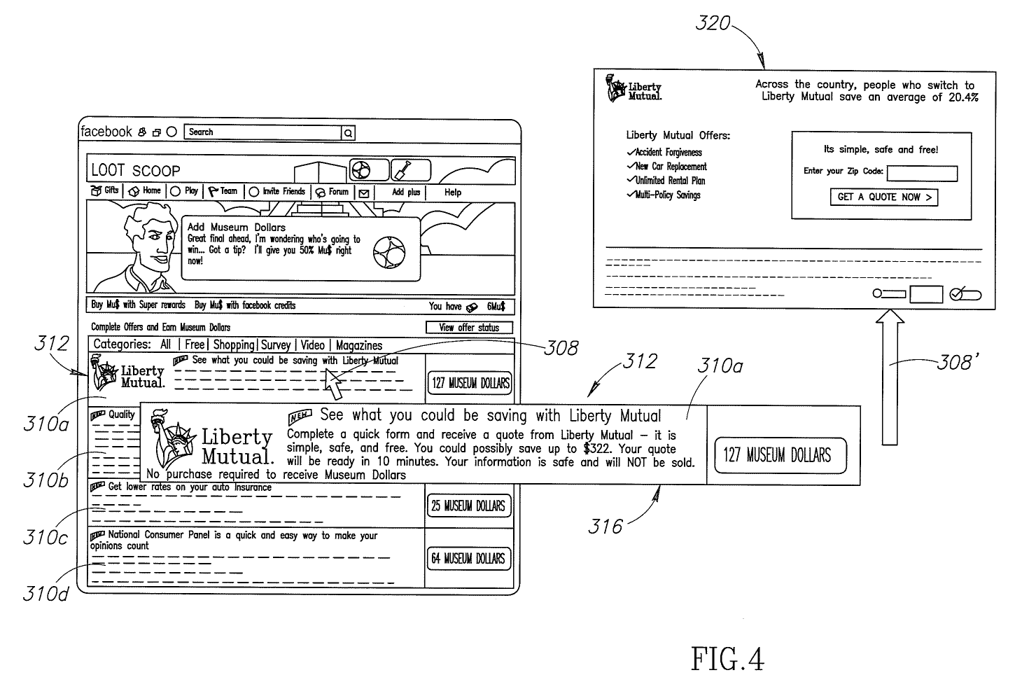

FIG. 2 is a flow diagram (flow chart) detailing an exemplary process performed in accordance with the disclosed subject matter. This process, as well as the other processes disclosed herein, are, for example, performed in real time. Attention is also directed to FIGS. 3 and 4, which are discussed with FIG. 2.

Prior to step 210, an exemplary user, for example user 41a, has directed his web browser to the URL of an Offer Wall 300 (FIG. 3), also known as a data object (for example, associated with the game “LOOT SCOOP”), that appears on the user's computer monitor or screen 41d. The offer wall 300 is, for example, rendered in a frame 302 from an offer wall host server 50, such as Facebook™ (with a URL of www.facebook.com), a portion 304 hosted by an application server 52, and a portion 306, listing various offers 310a-310d, also known as data objects, hosted by the home server 30, and provided, at least partially, through the database 32. As a preliminary step, user 41a may be required to enter a user ID and password before being presented with the Offer Wall 300. The Offer Wall 300, which is displayed on monitor 41d, contains an arrangement of links to Offers (portion 306) through which user 41a could earn or purchase virtual currency.

At step 210, user 41a, using his mouse 41c, clicks (represented by the arrow 308) on a link associated with an Offer 310a on the Offer Wall 300. The link underlies the offer 310a, of which the entire area 312 of the offer 310a is activatable. The link is activatable, and activates when the activatable area of the offer 310a is clicked on (the click represented by the arrow 308). The link is to the Offer 310a, and is actually a link to the home server (HS) 30 containing information about the particular Offer (for example, Liberty Mutual) that the user 41a chose to view. For example, in FIG. 4, the offer 310a with its activatable area 312 is shown enlarges and in detail in the block 316, with the click 308 on the offer 310a represented by the 308′. Once the click 308/308′ is made by the user 41a, using his mouse 41c or other pointing device, the link activates and the browser (browsing application) of the computer 41c of the user 41a is redirected to the web site, for example, the web page 320, hosted by a third party server 42a-42n.

At step 220, the home server (HS) 30 obtains or references the user's 41a user ID (if applicable), IP address, and/or device ID. The device ID is an identification number or string referring to a particular computer and can be read from a cookie stored by the user's 41a web browser and/or a browser plug-in, such as Adobe Flash®. The link to the Offer that the user 41a clicked on also contains information about the specific Offer that the user clicked on a link to.

In alternate embodiments, the link may also contain information relating to the Offer type, indicating, for example, whether the Offer is for purchasing virtual currency or instead for earning currency as a result of visiting, viewing, and completing any tasks and/or submitting any information required by the Offer. The information regarding the Offer that the user clicked on a link to is collected by the home server (HS) 30. In step 214, the home server (HS) 30 checks the Fraud Score database 33a (FIG. 1) to determine whether a Fraud Score has been associated with the user ID, IP address, and/or device ID associated with user 41a. If not, at step 216, the home server (HS) 30 generates an entry in the Fraud Score database 33a with the value of zero for the Fraud Score, and associates it with the user's 41a user ID, IP address, and/or device ID.

At step 218, the home server (HS) 30 retrieves from a database 33b (FIG. 1) a maximum threshold for the Fraud Score. In this particular example, there is only one maximum threshold stored in the database. In alternate embodiments, differing maximum thresholds may exist in the database, each one associated with a specific Offer or a specific type of Offer. In this particular example, the single maximum threshold in the database 33b acts as a “global” maximum threshold and applies to all Offers and all types of Offers.

At step 220, the home server (HS) 30 determines whether the Fraud Score for user 41a is greater than or equal to the maximum threshold. If so, the home server (HS) 30 blocks/ignores the click from user 41a. This is shown at step 222. More specifically, the home server (HS) 30 either does not redirect user's 41a computer 41b to the Offer, or it redirects user's 41a computer 41b to a web page that explains that the user 41a is being blocked due to suspected fraudulent activity.

If the user's 41a Fraud Score is below the maximum threshold, the home server (HS) 30 proceeds to retrieve a Risk Score associated with the Offer from a Risk Score database 33c (FIG. 1) at step 224. The Risk Scores are indexed by identification numbers or strings associated with each Offer and/or Offer type that an Offer Wall can display. The identification numbers or strings are embedded in the links to Offers displayed on the Offer Wall and are thereby passed to the home server (HS) 30 when a user 41a clicks on one of the links on the Offer Wall. An Offer to purchase virtual currency using payment credentials, such as a credit card number or PayPal® account information may have a higher Risk Score associated with it than an Offer that allows a user 41a to earn virtual currency as a reward for viewing an advertisement and/or completing tasks required by the Offer, for example providing information about himself.

Next, at step 226, the home server (HS) 30 adds the Risk Score associated with the Offer to the user's 41a Fraud Score, and saves it back in the Fraud Score database 33a (under categories such as user ID, IP Address, and Device ID). Finally, the home server (HS) 30 redirects the user's computer 41b to the URL of the Offer, also known as the target data object, which is typically hosted on a third party server (TPS) 42a-42n. For example, the user's browser would be redirected to the third party server 42a-42n hosting the “Liberty Mutual” offer 310, and in particular, hosting the web site with its web page 320 (the target data object).

Over time, the home server (HS) 30 continuously decreases the fraud score of user 41a. In this particular example, the fraud score is decremented by one every second. As a result, when the user 41a clicks on a link to an Offer to directly purchase virtual currency with, for example, credit card information, the user's 41a Fraud Score of, for example, zero, is increased by the Risk Score associated with the Offer, which is, for example 500. A global maximum threshold Fraud Score is set at 700, for example. If the user 41a quickly repeats the same action, the user's 41a Fraud Score increases to 1000, minus any seconds that passed between the first and second clicks on the Offer. At that point, the user 41a will be blocked from visiting any other Offers because the user's 41a Fraud Score of roughly 1000 is greater than the maximum threshold of 700.

It is to be understood that all communication between computers and databases as disclosed herein is possible because they are connected together as part of the same computer or networked together via a wired or wireless network. It should also be understood that the databases discussed herein could be embodied in one or more flat files or in relational databases, and that they could be stored in the memory of one computer or distributed across multiple computers.

The above-described processes, including portions thereof, can be performed by software, hardware, and combinations thereof. These processes and portions thereof can be performed by computers, computer-type devices, workstations, processors, micro-processors, other electronic searching tools and memory, and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

1. A computerized method for detecting fraud in obtaining virtual currency over a communications network, comprising:
a computerized component linked to the communications network receiving, over the communications network, an indication of a click associated with a user computer linked to the communications network, the click on a link to an offer to obtain virtual currency; and
determining whether the user computer has been assigned a fraud score representing the likelihood that the user computer is engaged in fraud.

2. The method of claim 1, additionally comprising:
a. obtaining a fraud score including:
obtaining the fraud score if a fraud score has been assigned for the user computer; or
assigning a fraud score for the user computer if a fraud score has not been assigned, including assigning a fraud score of zero to the user computer; and
b. evaluating the fraud score including:
if the fraud score of the user computer is greater than a pre-established maximum threshold, taking no further action; or
if the fraud score of the user computer is less than the maximum threshold, increasing the fraud score by a risk score associated with the offer, redirecting the user computer to the offer to obtain virtual currency; and continuously decreasing the fraud score of the user computer over time.

3. A computer-implemented method for detecting fraud in obtaining virtual currency over a communications network, comprising:
receiving, by at least one first server linked to the communications network, data associated with an activation of a link in a first data object to the at least one first server;
analyzing, by the at least one first server, the data associated with the activation of the link to obtain an identifier associated with at least one of i) the computer of the user linked to the communications network, or ii) the user, associated with the activation of the link;
obtaining a fraud score for the obtained identifier, by the at least one first server;
comparing, by the at least one first server, the obtained fraud score to a threshold fraud score; and
the at least one first server i) redirecting the browsing application of the computer of the user to a target data object if the obtained fraud score is below the threshold fraud score, or ii) blocking browser access to the target data object if the obtained fraud score is above the threshold fraud score.

4. The method of claim 3, wherein the first data object includes an offer wall and the target data object includes a web site linked to the offer wall, such that the browser of a computer of a user is redirected from the offer wall to the web site linked to the offer wall upon an activation of the link in the offer wall.

5. The method of claim 3, wherein obtaining a fraud score includes generating a fraud score for the obtained identifier, if a fraud score does not exist for the obtained identifier.

6. The method of claim 5, wherein the generating a fraud score includes the at least one first server assigning a fraud score for the obtained identifier.

7. The method of claim 6, wherein generating a fraud score initially includes calculating a risk score based on the time between activations of the link in the first data object.

8. The method of claim 7, wherein the obtained identifier is selected from the group consisting of a user identifier (ID), an internet protocol (IP) address and a device identifier (ID).

9. The method of claim 3, wherein the at least one first server includes one server.

10. The method of claim 3, wherein the at least one first server includes a plurality of servers.

11. A system for detecting fraud in obtaining virtual currency over a communications network, comprising:
at least one server for linking to a communications network comprising:
a storage medium for storing computer components; and
a processor for executing the computer components comprising:
a first component for receiving data associated with an activation of a link in a first data object to the at least one first server;
a second component for analyzing the data associated with the activation of the link to obtain an identifier associated with at least one of i) the computer of the user linked to the communications network, or ii) the user, associated with the activation of the link;
a third component for obtaining a fraud score for the obtained identifier;
a fourth component for comparing the obtained fraud score to a threshold fraud score; and
a fifth component for i) redirecting the browsing application of the computer of the user to a target data object if the obtained fraud score is below the threshold fraud score, or ii) blocking browser access to the target data object if the obtained fraud score is above the threshold fraud score.

12. The system of claim 11, wherein the at least one server includes one server.

13. The system of claim 11, wherein the at least one server includes a plurality of servers.

14. A system for detecting fraud in obtaining virtual currency over a communications network, comprising:
at least one first database for storing fraud scores associated with at least one of, users, internet protocol addresses or computers associated with users, which are linked to the communications network; and,
at least one second database for maintaining threshold fraud scores; and,
at least one server linked to the communications network, configured for:
receiving data associated with an activation of a link in a first data object to the at least one first server;
analyzing the data associated with the activation of the link to obtain an identifier associated with at least one of i) the computer of the user linked to the communications network, or ii) the user, associated with the activation of the link;
obtaining a fraud score for the obtained identifier from the at least one first database;
comparing the obtained fraud score to a threshold fraud score from the at least one second database; and
either i) redirecting the browsing application of the computer of the user to a target data object if the obtained fraud score is below the threshold fraud score, or ii) blocking browser access to the target data object if the obtained fraud score is above the threshold fraud score.

15. The system of claim 14, wherein the at least one server includes one server.

16. The system of claim 14, wherein the at least one server includes a plurality of servers.
